(19) United States
(12) Patent Application Publication
(10) Pub. No.: US 2005/0067934 A1
(43) Pub. Date: Mar. 31, 2005

(54) Discharge apparatus, plasma processing method and solar cell

(75) Inventors: Masashi Ueda, Kanagawa (JP); Tomoko Takagi, Kanagawa (JP); Norikazu Ito, Kanagawa (JP); Yoshimi Watabe, Kanagawa (JP)

Correspondence Address: BURNS DOANE SWECKER & MATHIS L L P, POST OFFICE BOX 1404, ALEXANDRIA, VA, 22313-1404, US

(73) Assignee: Ishikawajima-Harima Heavy Industries Co., Ltd., Tokyo (JP)

(21) Appl. No.: 10/670,476

(22) Filed: Sep. 26, 2003

(51) Int. Cl. H01J 17/26; H01J 61/28

(52) U.S. Cl. 313/231.31

(57) ABSTRACT

The object of this invention is to realize the new configuration of antenna and the electric power feeding method which substantially suppress the generation of standing wave and consequently to provide a discharge apparatus to generate plasma having an excellent uniformity, a plasma processing method for large-area substrate, and a solar cell manufactured with a high productivity. The present invention is composed of a plurality of U-shaped antenna elements having a power feeding end and a grounded end which are arranged to form an array antenna in such a way that the grounded end and the power feeding end are alternately placed in parallel at regular intervals on a plane, wherein the alternating current electric powers with the same excitation frequency are simultaneously fed to the power feeding ends with the phase shift of 180 degrees between adjacent power feeding ends, the excitation frequency of the alternating current power is 10 MHz-2 GHz, and the length of the conductor is set so that the measured ratio of reflected wave to incident wave is 0.1 or less at the power feeding end. It is also possible to determine the length La of straight conductor to hold the inequality: 0.5(1/α)<La<10(1/α). Here, α(1/m) is a attenuation coefficient.

### FIELD OF THE INVENTION

The present invention relates to a discharge apparatus, a plasma processing method, and a solar cell, and more particularly to the discharge apparatus to generate uniform plasma using an array antenna, the plasma processing method having an excellent productivity and uniformity, and the solar cell which can be manufactured with a high productivity.

### DESCRIPTION OF THE RELATED ART

Solar cells have been noted and expected as a clean energy source, but their cost reduction is indispensable for their spread. It has, therefore, been earnestly desired to provide an apparatus to deposit high quality a-Si film with uniform thickness distribution over large-area substrate at a high throughput. In addition to the solar cells, there is a strong demand in various fields for uniform processing on a large-area substrate. For example, in manufacture of thin film transistors for driving a liquid crystal display, the production line for large-area substrates having one side of 1 m or larger may soon be in full scale operation. In this production process, a plasma CVD method and dry etching method are employed. Moreover, considering the latest great interest on the environmental problems, the dry process may be soon employed in the removal process of photoresist with the aid of a plasma ashing.

The parallel-plate type (capacitively coupled type) plasma process apparatus has been widely employed in plasma process such as the plasma CVD, the dry etching, and the plasma ashing process. In this type of discharge apparatus, a substrate to be processed is placed on either a high frequency electrode to which high frequency power is supplied or a grounded electrode facing the high frequency electrode. A large DC potential difference called self-bias appears near the high frequency electrode surface to cause ions with high energy to bombard the substrate placed on the high frequency electrode. On the other hand, such phenomenon will not occur on the grounded electrode side. Consequently, the plasma gives a different influence on the substrate placed on the high frequency electrode from the substrate placed on the grounded electrode. Therefore, it is impossible to carry out the identical processing on both substrates placed on the respective electrodes.

Thus, only one surface facing one high frequency electrode plate can be processed in the parallel-plate type plasma processing apparatus. For this reason, in the case where simultaneous processes are made in the processing chamber, at most two surfaces can be processed by arranging two high frequency electrodes in the processing chamber to form two discharge regions. There is also an idea of multi-zone system which is adopted to further increase the number of discharge regions. However, it is practically very difficult to realize such system because of the disadvantage due to its complex structure and low maintainability of the parallel-plate type electrodes.

Moreover, in connection with this, the parallel-plate type discharge apparatus has another disadvantage. For example, when the film formation is made on a glass substrate using the plasma CVD method, a material gas introduced into the vacuum chamber is decomposed by the electrons in plasma to deposit a thin film not only on the glass substrate but also on the high frequency electrode. That is, nearly the same amount of material gas as that used for film deposition on the substrate is wastefully consumed for film deposition on the electrode. The thin films on the electrode may peel off and contaminate the space, which requires periodical removal of the films.

In addition, a desired characteristic can be hardly obtained when the substrate becomes large since the uniformity of plasma seriously deteriorates.

A variety of examinations have been made to form uniform plasma over a large-area substrate in order to carry out the uniform plasma processing. However, it is very difficult to generate uniform plasma over the large-area substrate with the parallel-plate type electrode system because the electrode becomes large with the substrate. This is attributed to the essential disadvantage of the parallel-plate type electrode system, as will be mentioned below. That is, as the electrode is enlarged, standing waves tend to appear on the electrode surfaces, causing the deterioration of plasma density uniformity. This nonuniform plasma distribution becomes more noticeable when higher frequencies such as in the VHF band is employed. For these reasons, the upper limit of the substrate size has been thought to be, for example, 0.3 m×0.3 m when the high frequency of 80 MHz is employed (U. Kroll et al. and Mat. Res. Soc. Symp. Proc. Vol. 557 (1999), p121-126).

In addition, this system requires the precise arrangement of two electrode plates with a prescribed distance all over the electrodes to generate plasma with uniform density, which is practically difficult as the substrate becomes large.

Under such a circumstance, other type of plasma CVD method using inductively coupled type electrodes has been proposed. This method is absolutely different in the mechanism for maintaining the discharge from the capacitively coupled type plasma CVD method. This method does not require precise arrangement of electrodes, and high-density plasma can be obtained using the excitation frequency in the VHF band which is advantageous for depositing high quality a-Si film at high deposition rate. The plasma CVD apparatus using inductively coupled type electrodes are exemplified in Japanese Patent Laid-Open 4-236781 that employs a ladder-shaped electrode and in Japanese Patent No. 2785442 that employs a zigzag-folded electrode.

### DISCLOSURE OF THE INVENTION

The present inventors investigated a variety of inductively coupled electrodes including the above-mentioned electrodes and found that as the inductively coupled electrodes such as the ladder-shaped or zigzag-folded electrodes become larger, the current flowing on the electrodes tends to vary with the positions and standing waves appear at unexpected positions. In short, it was found difficult to create uniform plasma to cope with the large-area substrates so long as the electrode structures of the prior art are employed.

Accordingly, the present inventors carried out fundamental investigations on the plasma homogenization using the inductively coupled electrodes and developed several antenna structures that positively utilize the standing waves that caused the deterioration of uniformity in the prior art inductively coupled electrode system. Here, for instance, a U-shaped antenna was used, which had a power feeding portion at one end and a grounded portion at the other end. The distances from the turning portion to the feeding portion and the grounded portion were set to be a half wavelength of the high-frequency wave to establish the standing wave at predetermined position over the electrode (PCT/JP 00/06189). Moreover, the antenna having such structure is used to construct array antenna, which makes it possible to generate plasma more uniformly over the larger area.

However, this film forming method makes use of a standing wave appearing on the antenna. Therefore, there is to some extent nonuniform distribution of the plasma density along the antenna due to the existence of standing wave. This distribution can be reduced by some method. For example, the uniformity may be improved by feeding intermittently the electric power to drive the antenna (“Large-area film formation of a-Si:H by the VHF-PECVD method using the new type electrode”, the 61st Autumn Meetings of Japan Society of Applied Physics, p.841, September, 2000). However, these methods cannot completely eliminate the nonuniform distribution due to the influence of standing wave.

Moreover, since the standing wave is utilized, the plasma density distribution is also influenced greatly by the variation of the geometrical length of antenna and excitation frequency.

Thus, the object of this invention is to realize the new configuration of antenna and the electric power feeding method which substantially suppress the generation of standing wave, and consequently to provide a discharge apparatus for generating plasma having an excellent uniformity, a plasma processing method for large-area substrate, and a solar cell manufactured with a high productivity.

During the investigation on the feeding method of high frequency power, the electrode configuration, the film forming conditions and the like to attain the above-mentioned object, the present inventors have found out that special effect appears in array antenna system where a plurality of antenna elements are arranged, and completed this invention by further examining film thickness uniformity on the basis of above-mentioned findings.

The discharge apparatus of this invention has the following configuration.

A first and a second straight conductor with the same length are placed in parallel and electrically connected each other at the one end to construct an antenna element in U-shape. The other ends, unconnected ends, of first and second straight conductors of antenna element are a grounded and a power feeding end, respectively. Alternating current power is fed to the power feeding end.

A plurality of the antenna elements are arranged in parallel at regular intervals on a plane in a vacuum. The grounded ends and the power feeding ends are alternately arranged. The plurality of antenna elements forms an array antenna to generate a discharge plasma in the vacuum. Alternating current powers with the same excitation frequency are simultaneously fed to the array antenna having such a geometrical configuration. The excitation frequency is 10 MHz-2 GHz.

With the adoption of such configuration and excitation method, the standing wave appears on the antenna element as mentioned above. The electromagnetic wave is propagated along the antenna as an incident wave from the power feeding end to propagates, and is reflected at the grounded end to return as a reflected wave. Therefore, the standing wave is generated as a result of interference of the incident wave and the reflected wave. The first subject of this invention is to reduce the influence of this standing wave on the plasma uniformity.

Moreover, when a plurality of antenna elements are driven, the complicated interaction takes place between antenna elements, which may often make electromagnetic field uncontrollable. This is the second subject to be solved of this invention.

First, the present inventors reached a conclusion that the principle of superposition should be employed in order to solve the second subject.

This will be explained. FIG. 5 shows conceptual diagrams of currents flowing array antenna when the phase between adjacent power feeding ends of antenna elements is made (A) in-phase and (B) anti-phase.

The antenna element 2 is composed of two tracks of straight conductor which are connected each other (#1 and #2 or #3 and #4) and have a power feeding end 9 and a grounded end 10. In the drawing, the direction of arrow shows the phase of electric current. That is, the current flows in the arrow direction at the observation and the upward arrow is assumed “plus” for convenience. The magnitude of the arrow means the magnitude of electric current and therefore the large current flows at the observation on the power feeding side (on the straight conductor with odd number).

The track #2 is located between large currents flowing through tracks #1 and #3 in the case of in-phase power supply (FIG. 5A). Therefore, the electric fields in the vicinity of track #2 is thought to be greatly influenced by two large currents flowing the straight conductors adjacent to track #2. Next, in the case of anti-phase power supply (FIG. 5B), track #2 is located between a large “minus” current of track #1 and a large “plus” current of track #3. According to the principle of superposition, two effects having the same magnitude and opposite directions will be cancelled. Therefore, the electric field in the vicinity of track #2 is thought to be little influenced by the currents flowing through straight conductors adjacent to track #2. Although the influence of currents on the electric field has been explained by assuming the current distribution pattern on the antenna element as a matter of convenience, the similar result will be obtained for any current distribution so long as electrically equivalent antenna elements are arranged.

Therefore, in the case where the antenna elements with the same configuration are arrayed, the influence of the current flowing on adjacent antenna elements as well as the backward current (or forward current) can be substantially cancelled by inverting the phase between adjacent antenna elements. As a result, the current flowing on straight conductor is thought to behave like the current on the single track. That is, the interaction between antenna elements can be neglected in practice by feeding the anti-phase electric power to the adjacent antenna elements, and accordingly the second subject can be solved.

Next, the first subject has been studied using the technology in the field of the radio wave transmission engineering which is a different technical field from this invention; that is, using the concept of a loaded antenna. The loaded antenna is one used for communication in which the opposite side of power feeding point is grounded through a load with suitable impedance. Such configuration prevents the reflection in wide frequency range since the electromagnetic energy propagated along the antenna will be consumed by the load. Then, the present inventors attempted to apply the idea of loaded antenna to plasma processing apparatuses and found that the similar effect was observed even in the experimental system constructed without installing the load. Here, the plasma itself surrounding the antenna seems to play a role of load as a distributed constant circuit.

These are summarized as follows. When the phase of power is shifted by 180 degrees between adjacent power feeding ends of array antenna, the straight conductors of array antenna can be assumed as the single guide for electromagnetic wave propagation existing in the plasma, which makes it possible to reduce the nonuniform plasma density distribution arising from the interaction between antenna elements. In addition, the interaction of electromagnetic wave and the plasma is made large enough to absorb almost all the energy of electromagnetic wave, which may prevent the standing wave and reduce the nonuniform distribution of plasma density along the conductors. Consequently, it is possible to generate more uniform plasma over the entire array antenna.

Here, the magnitude of standing wave can be estimated by measuring an incident wave and a reflected wave at the power feeding end of antenna. The interaction of electromagnetic wave and plasma is observed as the decrease of reflected wave since electric power will be absorbed by the plasma if the interaction is sufficiently large. Therefore, such large interaction is observed when the geometrical length of antenna is long enough or when the discharge pressure is high enough to easily cause the energy transfer. It was also found that the distribution due to standing wave disappeared and the uniformity of film thickness was improved when the ratio of reflected electric power to the incident electric power became 10% or less. That is, the geometrical length of antenna can be determined with reference to the magnitude of reflected wave, depending on plasma parameters.

The method for determining the length of straight conductor (antenna length) La from the ratio of reflected wave to incident wave has been described so far in order to obtain the uniform plasma. It is also possible to determine the proper antenna length on basis of attenuation coefficient α of electromagnetic wave. That is, the antenna length La can be determined to hold the inequality: 0.5(1/α)<La<10(1/α), which substantially eliminates the standing wave and improve the plasma distribution. This will be explained below.

As shown in FIG. 6, a sheath 61 and plasma 63 exist around antenna 60. Since the plasma 63 spreads to considerably distant position from antenna 60, it seems that the behavior of electromagnetic wave traveling on the antenna should be considered over the whole plasma region or over the all region in the vacuum chamber where the discharge is induced. However, the electromagnetic wave cannot be propagated in the plasma except for the case where the plasma density is very low or the excitation frequency is very high. This is called cut-off state where the electric field penetrates to some extent into the plasma but the electromagnetic wave cannot be propagated to any far position when the frequency of electromagnetic wave is below the plasma frequency fₚ(=ωₚ/(2π)). Therefore, the plasma in the region near the antenna should mainly influence the propagation characteristics.

Then, a virtual boundary 62 is introduced to define this region. The radius d of this region 62 is approximately expressed using so-called skin depth δ. The skin depth δ is a distance from the surface to the position where the electric field is attenuated to 1/e times (where e denotes the base of natural logarithm) when the plane electromagnetic wave is incident perpendicularly into the plasma in the cut-off state, and is given by Equation (1) under the cold plasma approximation/linear approximation where the collisions cannot be neglected (For example, Michael Alieberman and Allan J. Lichtenberg, “Principles of Plasma Discharge and Materials Processing”, John Wiley & Sons, and Inc. 1994 p390).

$$δ = - ( \frac{ω}{c} ) Im [ \sqrt{{κ}_{p}} ] \qquad ( 1 )$$

Here, c denotes the velocity of light, κₚ a complex specific dielectric constant of the plasma expressed by Equation (2), and ω(=2πf) angular frequency (f is excitation frequency to drive the antenna).

$${κ}_{p} = 1 - \frac{{( \frac{{ω}_{p}}{ω} )}^{2}}{1 - j \frac{v}{ω}} \qquad ( 2 )$$

Here, υ and wₚ(=2πfₚ) denote collision frequency and plasma angular frequency, respectively. The plasma frequency fₚ is approximately estimated with the plasma density n(m⁻³) from the equation: fₚ(Hz)=8.98·n^{0.5}.

Thus, once the virtual boundary d(=δ) is defined, the attenuation coefficient α can be calculated since the electromagnetic wave traveling along the antenna can be considered as that traveling along a coaxial transmission line. Then, the present inventors employed attenuation coefficient α as a means for determining the antenna length.

The attenuation coefficient α in this case is expressed as the following equations using inductance L and electrostatic capacity C per unit length of antenna for the virtual boundary d.

$$\begin{matrix}LC = \frac{{μ}_{0 } ln \frac{d}{a}}{\frac{1}{{ɛ}_{0}} ln \frac{c}{a} + \frac{1}{{ɛ}_{0} {κ}_{p}} ln \frac{d}{c}} & ( 3 ) \\ α = - Im [ ω \sqrt{LC} ] . & ( 4 )\end{matrix}$$

μ₀ and ε₀ are permeability and dielectric constant of vacuum, respectively.

Since Equations (1)-(4) have too many parameters for describing the phenomenon, the present inventors modified Equation (4) of attenuation coefficient α to the simple form for practical use under some assumption and then examined whether the attenuation coefficients obtained under such assumption could explain the experimental results in the wide range.

First, the radius a of antenna was assumed to be 3 mm, judging from realistic antenna diameter. The thickness of sheath was estimated to be 4 mm from expected plasma parameters and therefore c=7 mm. The inventors also examined different values and confirmed that the values did not much change the result in most cases so long as the values are practical ones. Moreover, the plasma density was assumed to be 2×10¹⁵(m⁻³). The plasma density used in the plasma processing is usually in the range of 1×10¹⁵(m⁻³) to 1×10¹⁶(m⁻³) except for so-called high-density plasma. That is, the range of plasma density to be adopted is not so wide.

Next, the collision frequency υ is given by

$$v = \frac{〈 v 〉}{{λ}_{m}} = \frac{6.213 \times {10}^{5}}{\frac{{λ}_{m0}}{p}} = \frac{6.21 \times {10}^{5}}{6.40 \times {10}^{- 3} / p} = 9.70 p \times {10}^{7} \qquad ( 5 )$$

under the one-electron approximation using discharge pressure p (Pa). In Equation (5), the collision cross section of Ar was used to calculate the mean free path λₘ. The collision cross section is varied with the kinds and constituent ratio of gas, but will not have an extremely different value except for the special cases of molecules such as a polymer having a large molecular weight. In addition, the electron temperature was assumed to be 10,000K. The temperature will not change remarkably in the case of low pressure discharge, and changes to at most several times.

Under the above-mentioned assumptions, following equations (1′)-(4′) can be derived.

$$\begin{matrix}δ = - 2.10 f \times {10}^{- 8} Im [ \sqrt{{κ}_{p}} ] & ( {1}^{′} ) \\ {κ}_{p} = 1 - \frac{\frac{1.61 \times {10}^{17}}{{f}^{2}}}{1 - j1 .54 ( \frac{p}{f} ) \times {10}^{7}} & ( {2}^{′} ) \\ LC = \frac{1.26 \times {10}^{- 6} ln ( \frac{δ}{3 \times {10}^{- 3}} )}{9.57 \times {10}^{10} + \frac{1.13 \times {10}^{11}}{{κ}_{p}} ln ( \frac{δ}{7 \times {10}^{- 3}} )} & ( {3}^{′} ) \\ α = - Im [ 6.28 f \sqrt{\frac{1.26 \times {10}^{- 6} ln ( \frac{δ}{3 \times {10}^{- 3}} )}{9.57 \times {10}^{10} + \frac{1.13 \times {10}^{11}}{{κ}_{p}} ln ( \frac{δ}{7 \times {10}^{- 3}} )}} ] & ( {4}^{′} )\end{matrix}$$

The attenuation coefficient α and its reciprocal is calculated. The reciprocal of attenuation coefficient whose unit is meter has the physical meaning that the magnitude of electromagnetic wave is attenuated to 1/e at the distance of 1/α from the power feeding position of the coaxial transmission line. Then, the length La of straight portion of array antenna may properly have values near the reciprocal of attenuation coefficient. That is, if the length La is too short compared with the reciprocal of attenuation coefficient, the electromagnetic wave will not be sufficiently attenuated on the way to the grounded end. Accordingly, the standing wave is expected to appear since the reflected wave is produced at the grounded end. On the other hand, if the length is too long compared with the reciprocal of attenuation coefficient, the discharge cannot be generated over the entire antenna and therefore the plasma is located mainly in the vicinity of power feeding position. Then, 0.5 times of and 10 times of the reciprocal of attenuation coefficient were tentatively calculated as a function of discharge pressure for several excitation frequencies. Some of these calculation results on the relation between pressure and La are shown in FIGS. 7-9 when the excitation frequency is 10 MHz, 85 MHz or 400 MHz.

The present inventors confirmed that the optimum lengths of straight portion lie in the regions surrounded by two curves shown in FIGS. 7-9, which will be described later in the Embodiments. That is, the length of straight portion is determined to satisfy the inequality:
0.5(1/α)<the length of straight portion La<10(1/α) (6)
Since the plasma density was assumed to be 2×10¹⁵(m⁻³), the cut-off frequency is calculated to be 400 MHz.

As has been mentioned, the length La of straight portion can be estimated with two parameters of excitation frequency and discharge pressure. Here, Equations (1′)-(4′) have been derived to meet the experimental results by giving priority to the convenience and practical use and by restricting the application to discharge apparatuses or plasma processing.

Two methods have been described for determining the length of straight portion of antenna so far. In each case, the antenna preferably has a diameter of 10 mm or less. The selection of smaller diameter in the straight portion can generate plasma more easily over the entire length of antenna. In other words, the selection of smaller diameter has an effect to shorten the electrical length of antenna. This may be attributed to the fact that the diameter of antenna has the correlation with the strength of the interaction between electromagnetic wave and plasma. That is, it is likely that the energy transfer due to the oscillating sheath will become larger as the diameter of straight portion is larger (O. A. Popov and V. A. Godyak, J. Appl. Phys. 57, 53(1985)) and therefore the ratio of capacitive coupling in electric coupling between antenna and plasma will increase.

The diameter of antenna influences the selection of antenna length as mentioned. However, the influence is not so strong that the optimal length of straight portion of antenna still lies in the region obtained from Equation (6) even when the small diameter is selected. The thinner antenna is advantageous for large area processing though the shape stability is decreased. The selection of antenna which is so thin as to easily cause plastic deformation during handling is not appropriate from the viewpoint of the manufacturing and maintenance of antenna. In addition, considering the power loss and heat generation due to electric current flowing on the antenna, the diameter of straight portion is desirably selected to be 1 mm or larger.

The diameter of straight portion has the correlation with the electromagnetic wave propagation on antenna as has been mentioned. This can be positively made use of. That is, when the antenna with a constant diameter over the entire length of straight portion is employed, the plasma density is distributed nonuniformly due to the attenuation of electromagnetic wave. The plasma distribution may be required to have high density only near the substrate body to be processed. Then, the specific design condition in the vacuum chamber may cause the deterioration of plasma uniformity. In order to cope with such plasma distributions, the inventors found that the plasma density was controlled by varying the diameter along the straight portion and that this effect became more remarkable by providing the portion having a diameter of 10 mm or less.

As mentioned above, the propagation coefficient of the electromagnetic wave traveling along antenna is definitely governed by the sheath and the plasma around the antenna. Here, when straight portion is covered with a dielectric such as ceramics like alumina and a plastic like Teflon (trademark), the electromagnetic wave will be propagated through the space constructed with the dielectric, the sheath and the plasma around the antenna. This makes it possible to generate uniform plasma in wider range even if the geometrical length of straight portion is same, which was also observed in the cases where the diameter of straight portion was 10 mm or less and where the diameter was varied in the straight portion.

In addition, it is preferable to vary the thickness of dielectric in the longitudinal direction of the electrode. For example, in order to suppress the high plasma density near the power feeding portion which is caused by the unattenuated electromagnetic wave, the dielectrics is preferably made thick near the feeding portion and made thin for the rest of electrode. In contrast, in order to increase the plasma density near the substrate body to be processed, the dielectric is preferably made thin in its vicinity. Moreover, it is desirable to gradually vary the thickness in the longitudinal direction of straight portion. Thereby, a steep change of impedance at the edges of dielectric is suppressed, which makes it possible to form more uniform plasma. Instead, the dielectric may be wound around the electrode to yield a helix. Thereby, the plasma density distribution is flattened at the dielectric edge, and thus is made more uniform along the electrode.

Using the array antenna of this invention, the slab-like discharge plasmas can be formed surrounding the array antenna. Therefore, the identical plasma processing is carried out on substrate bodies placed on two planes on respective sides of array antenna. Thereby, the processing capacity doubles and the utilizable ratio of material gas also doubles.

In the case of conventional parallel-plate type processing apparatus, at most two discharge regions are provided in the vacuum chamber. In contrast, since the simple configuration and lightweight of antenna element makes it possible to dismantle and reassemble the array and the power feeding ends are provided on the side in this invention, a plurality of discharge regions can be easily formed in the vacuum chamber. Thus, the productivity is further improved.

Then, the configuration in which the substrate bodies are placed on both sides of array antenna is repeatedly provided in plurality in the vacuum chamber. This further improved the productivity.

A plasma processing method of this invention comprises; arranging a plurality of antenna elements, each having a configuration in which a first and a second straight conductor with the same length are placed in parallel and electrically connected each other at the one end to have a grounded end at the other end of first straight conductor and a power feeding end of alternating current power at the other end of second straight conductor, to form an array antenna in such a way that the first and the second conductor are alternately placed in parallel at regular intervals on a first plane in a vacuum, and feeding alternating current power to said array antenna to generate a discharge plasma in the vacuum,
wherein the alternating current electric powers with the same frequency are simultaneously fed to said power feeding ends with the phase shift of 180 degrees between adjacent power feeding ends, the excitation frequency of the alternating current power is 10 MHz-2 GHz, and the length of said conductor is set so that the measured ratio of reflected wave to incident wave is 0.1 or less at the power feeding end, or
wherein the alternating current electric powers with the same excitation frequency are simultaneously fed to said power feeding ends with the phase shift of 180 degrees between adjacent power feeding ends, the excitation frequency of the alternating current power is 10 MHz-400 MHz, and the length La of the straight conductor is set to hold the inequality:
0.5(1/α)<La<10(1/α)
wherein α(1/m) is a attenuation coefficient given by

$$α = - Im [ 6.28 f \sqrt{\frac{1.26 \times {10}^{- 6} ln ( \frac{δ}{3 \times {10}^{- 3}} )}{9.57 \times {10}^{10} + \frac{1.13 \times {10}^{11}}{{κ}_{p}} ln ( \frac{δ}{7 \times {10}^{- 3}} )}} ]$$

Here, κₚ is dielectric constant of plasma expressed by

$${κ}_{p} = 1 - \frac{\frac{1.61 \times {10}^{17}}{{f}^{2}}}{1 - j1 .54 ( \frac{p}{f} ) \times {10}^{7}}$$

using the excitation frequency f and discharge pressure p (Pa), and δ (m) is a skin depth of the electromagnetic field penetrating into the plasma is expressed by
δ=−2.10ƒ×10⁻⁸Im[\sqrt{κₚ}]

A solar cell of this invention comprises a semiconductor thin film including Si element formed using plasma CVD method of this invention.

The substrate body of this invention includes so-called glass substrate, silicon wafer, film (rolled film is also available), block and the like of insulator such as glass, semiconductor or metal. Moreover, the discharge apparatus of this invention can be used for the synthesis of materials such as polymerization of organic substances or the decomposition treatment of gases such as the exhaust gas, in addition to the substrate processing described above.

### BRIEF DESCRIPTION OF THE DRAWINGS

FIG. 1 is a schematic sectional view showing an example of discharge apparatus of this invention.

FIGS. 2A-2C are schematic views showing examples of antenna element.

FIG. 3 is a schematic sectional view showing a discharge apparatus which can simultaneously process a plurality of substrates.

FIG. 4 is a graph showing the relation between power feeding method and film thickness distribution.

FIGS. 5A and 5B are conceptual views explaining the interaction between antenna elements.

FIG. 6 is a conceptual sectional view showing the surrounding of antenna.

FIG. 7 is a graph showing the relation between the appropriate antenna length and pressure for the excitation frequency of 10 MHz.

FIG. 8 is a graph showing the relation between the appropriate antenna length and pressure for the excitation frequency of 85 MHz.

FIG. 9 is a graph showing the relation between the appropriate antenna length and pressure for the excitation frequency of 400 MHz.

Here, numeral 1 denotes vacuum chamber, 2; antenna element, 3; dielectric, 4; turning portion, 5; gas introduction port, 6; exhaust port, 7; high frequency power source, 8; coaxial cable, 9; power feeding end, 10; grounded end, 11; substrate body, 12; substrate holders, 60; antenna, 61; sheath, 62; virtual boundary, 63; plasma.

### DESCRIPTION OF THE PREFERRED EMBODIMENTS

The embodiments of this invention are explained below with reference to the drawings.

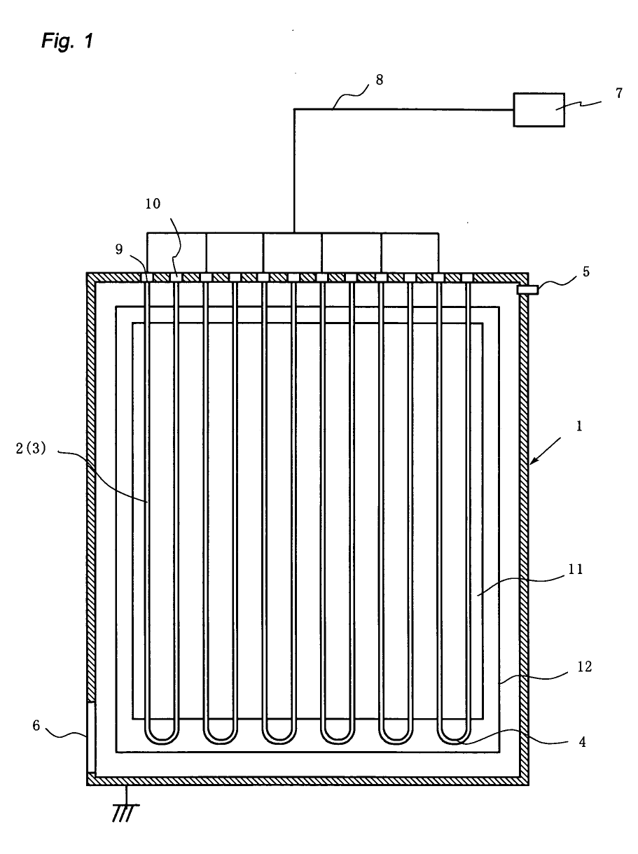

FIG. 1 is a schematic sectional view showing an example of array antenna used for the discharge apparatus of this invention. As shown in FIG. 1, a plurality of U-shaped antenna elements 2 are arranged facing a substrate 11 in a vacuum chamber 1 which has a gas introduction port 5 and an exhaust port 6. The one end, power feeding end 9, of each antenna element is connected to a high frequency power source 7 through a coaxial cable 8, and the other end, grounded end 10, is connected to the wall of vacuum chamber 1 to be electrically grounded.

Here, the length between power feeding 9 and grounded end 10, and a turning portion 4 (i.e., the length La of straight conductor) is determined so that the ratio of the reflected wave to the incident wave is 0.1 or less at the power feeding end or Equation (6) holds. The antenna surface is covered with dielectric 3 such as Teflon (trademark).

The antenna element 2 is preferably employed which is constructed, for example, by bending a straight conductor made of stainless steel, Al, Cu or the like into the U-shape. The antenna element in a rectangular shape is also available. The antenna element is not necessarily required to be one body. Therefore, the configuration in which two straight conductors are jointed and fixed with a metal plate or the like is also available. The straight conductor may be composed of one substance or different substances combined.

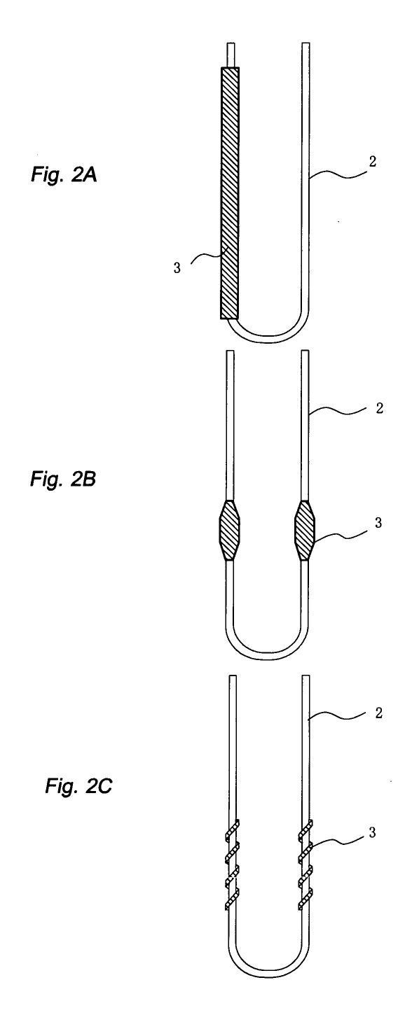

The dielectric 3 may be formed on the surface of the straight portion entirely or partially. In any case, the film thickness uniformity can be improved. The position and shape of the dielectric are determined according to the pattern of plasma density distribution (or film thickness distribution). For example, as shown in FIG. 2A, the dielectric can be formed only on the straight portion on the power feeding side. In this configuration, the increase of the plasma density is suppressed on the power feeding portion side, which homogenizes the plasma density over the whole antenna. Moreover, if the antenna is provided with the dielectric only on the positions corresponding to high plasma density, the uniformity can be further improved in the longitudinal direction of the antenna element.

Here, when the dielectric becomes too thick, the plasma density may increase at the edge of dielectric. In this case, the dielectric preferably has a tapered edge in the cross-section, as shown in FIG. 2B. That is, the thickness of dielectric is gradually decreased towards the end of dielectric. The peak of plasma density is prevented at the dielectric edge. The dielectric may be wounded spirally around the longitudinal direction of the electrode as shown in FIG. 2C, which averages the plasma density in the dielectric edge region.

The thickness and dielectric constant (or material) of dielectric is appropriately determined, depending on the plasma density distribution. In the case of, for example, Teflon, the preferable thickness is 0.1 mm or more. As the dielectric, any material that is stable to plasma and heat is employed. That is, organic materials such as Teflon or inorganic materials such as alumina and quartz are employed. However, the material having a large dielectric loss should be avoided.

As a method for alternately feeding anti-phase high frequency power to a plurality of antenna elements, for example, coaxial cables equivalent to the half wavelength may be added to every other power feeding end of antenna elements. Instead, a phase shifter may also be equipped to the high frequency power source to feed the high frequency power shifted by a half-wavelength to every other power feeding end.

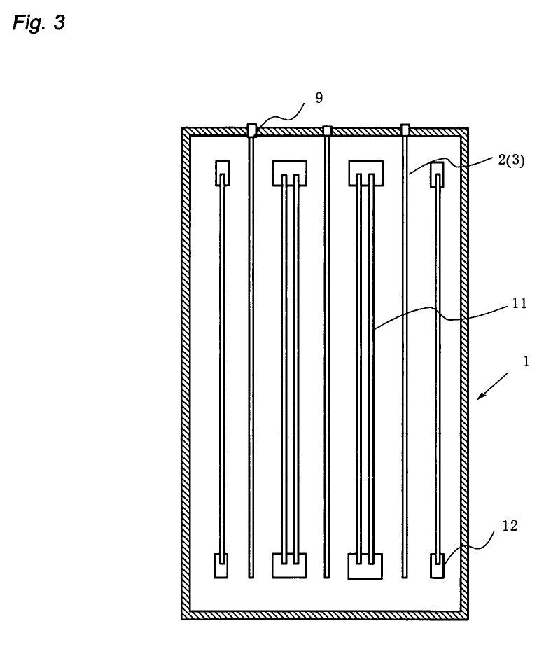

As shown in FIG. 3, the plasma CVD apparatus of this invention is constructed by arranging a plurality of antenna elements so as to cover substrate body width to form an array antenna, then arranging a plurality of array antennas with a prescribed interval, and placing substrate bodys 11 to be processed on both sides of each array to form multi-zone. With this configuration, the simultaneous plasma processing on a number of substrate bodies (that is, six substrates in the case of drawing) is made possible, which drastically increases the throughput. Moreover, since the distance between the array antenna and the substrate body can be made as small as about 30 to 60 mm, it is possible to realize the discharge apparatus which has high throughput per floor space of the apparatus.

### Example

Next, examples are given below to explain this invention more concretely.

The following experiments were carried out using the plasma processing apparatus shown in FIG. 1. Using three types of antenna elements with the straight portion lengths of 0.5 m, 1.0 m, and 1.6 m, the measurement of reflected power and the visual observation of plasma density distribution were made at the conditions of excitation frequency of 50 MHz and discharge pressure of 10 Pa. In the case of the antenna with the length of 0.5 m, the discharge could not be induced. When the antenna with the length of 1.0 m was employed, the plasma was generated but the reflection was larger than 10% of the incident wave. The plasma was observed to have a distribution that the density was high around the center of straight portion and decreased towards the ends. In contrast, when the antenna with the length of 1.6 m was employed, the reflection power became very small, and the light and darkness of the plasma was hardly observed.

Next, the discharge pressure was adjusted to 20 Pa to carry out the same observation. The discharge was produced even for the 0.5 m antenna, but the reflected wave was beyond 10%. In this case, the plasma density was observed to be high at the jointed portion (in the vicinity of folded-back portion) and the radiation from plasma decreased towards the power feeding end and the grounded end. At this pressure (20 Pa), the reflection power was measured small and the uniformity of plasma density was high for both antenna systems (1.0 and 1.6 m).

As mentioned above, it was found possible to suppress the reflected wave and the nonuniform distribution of plasma due to the standing wave by employing the antenna with a suitable length or longer. It was also found as a result of experiments under various discharge conditions that high uniformity of plasma was maintained by determining the length of straight portion so that the ratio of reflected wave to incident wave is 10% or less, and that the reflected wave did not increase even when the antenna with the longer straight portion was employed

Based on the above results, the plasma CVD apparatus with an array antenna having the straight portion length of 1.6 m was constructed to carry out the quantitative observation at the excitation frequency of 85 MHz. The straight portion of antenna was covered with 1 mm thick Teflon (trademark). The mixed gas of SiH₄/H₂=0.2 was used for the discharge.

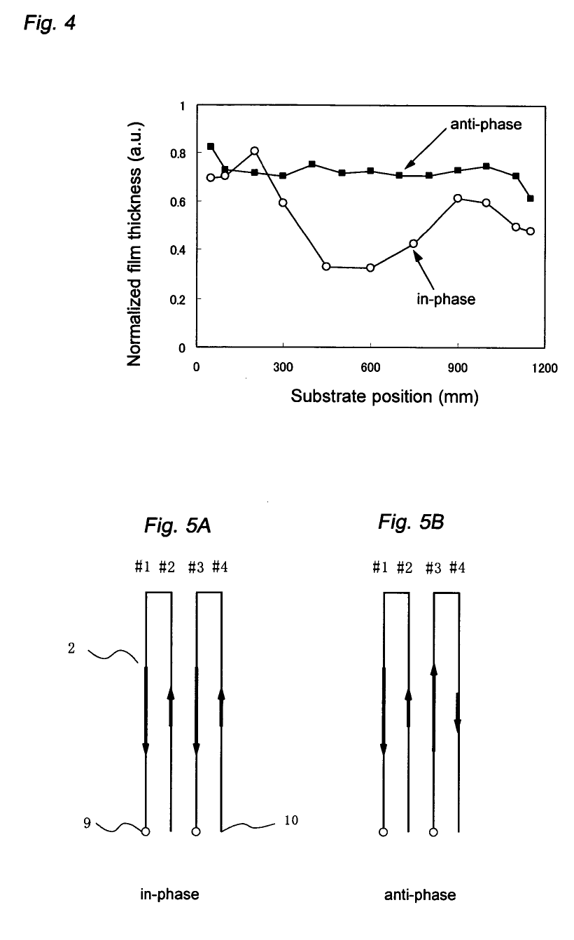

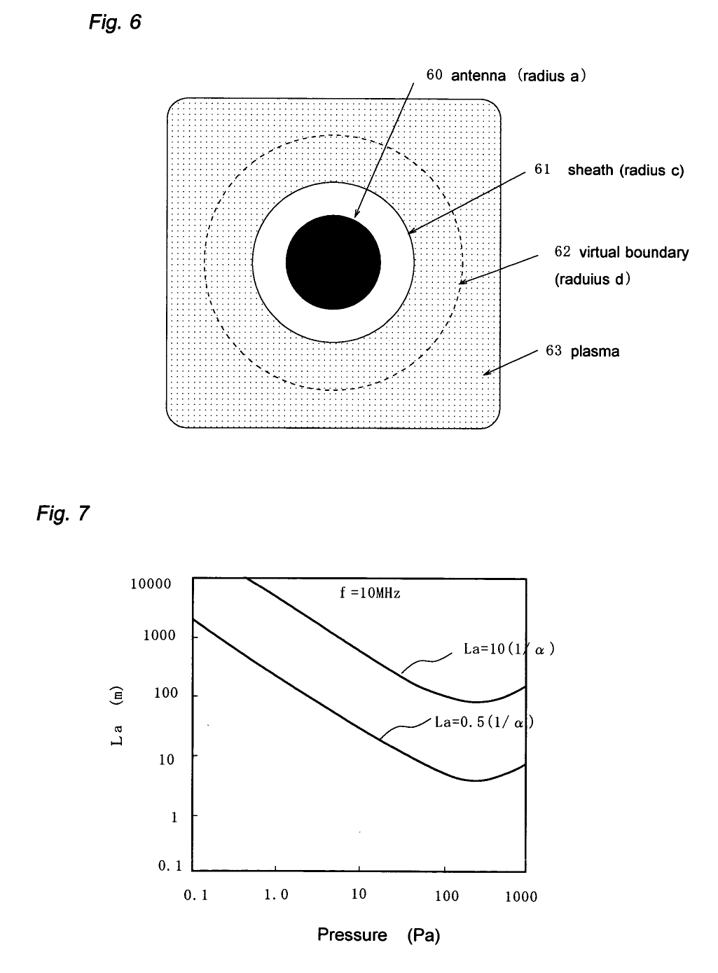

The in-phase power was fed to each antenna element, which results in low uniformity of the film thickness, as shown in FIG. 4. Next, the phase at each antenna element was shifted by 180 degrees and the film formation was made at various pressures. As shown in FIG. 4, the high uniformity of the film thickness is obtained at a discharge pressure of 2-3 Pa. The reflected wave was less than 3% of incident wave. The experiments at lower pressures were not made because of the restrictions on the pumping speed of apparatus.

When the excitation frequency was lowered, the reflected wave was increased and the uniformity was decreased in the film thickness distribution. That is, it was confirmed that the decrease in excitation frequency had an effect equivalent to the decrease in the electrical length of straight portion, even if the geometric length of the straight portion of antenna is not changed.

Then, the similar experiments were made in the pressure range of 0.1-1000 Pa using the array antenna with the straight potion length of 1.6 m and the relations shown in the graphs of FIGS. 7 -9 were studied.

First, the consideration will be made on the case where the excitation frequency to drive the antenna is 10 MHz. FIG. 7 may suggest that the straight portion length is required to be tens of meters to tens of thousands of meters in a low pressure region, and that the nonuniform distribution of plasma and the increase of reflected wave due to standing wave will take place without such extremely long antennas. That is, the geometrical length of 1.6 m of straight portion was expected to be too short. In the experiments, the discharge was not induced at the pressure of 100 Pa or less. The discharge was induced at the higher pressure; however, the reflected power was almost as large as the incident power in this pressure region.

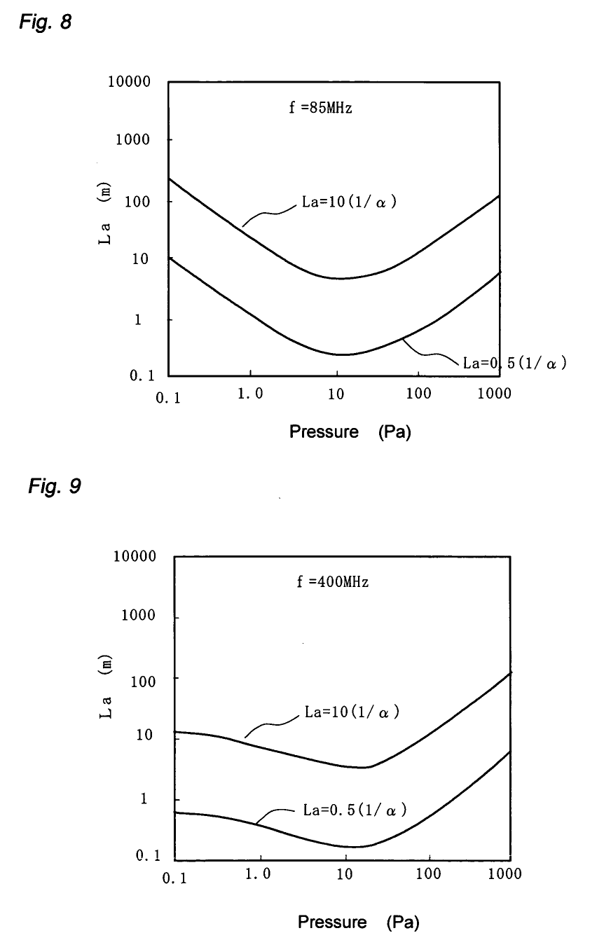

Next, the consideration is made on the excitation frequency of 85 MHz. In this case, the straight portion length of 1.6 m lies between 0.5(1/α) and 10(1/α) in the pressure region of 1-100 Pa as shown in FIG. 8. Therefore, it is expected that the reflected power becomes small and the discharge spreads over the entire length of antenna. The experiment results were as follows. The discharge plasma was not generated at a pressure of 0.1-0.6 Pa, but generated at the higher pressure. The reflected wave was particularly small at a pressure of 2-3 Pa, and the high uniformity of the plasma was confirmed by visual observation. The lower plasma density around the antenna edge was observed at a pressure of 10 Pa to tens of Pa, which might be attributed to large electrical length of antenna. The discharge was not induced in the low-pressure region as mentioned. It is likely that the supplied power was too small to cause ignition since the collision frequency seems small at these pressure.

Then, the case of excitation frequency of 400 MHz will be explained. As shown in FIG. 9, the length of the straight portion is close to 10 times of (1/α) at the pressure of about 10 Pa, and therefore the plasma density is expected to decrease at the end of antennal and the reflected wave is expected to be small. This phenomenon was observed at the pressure around 10 Pa in the experiments. Then, the small reflection and the high plasma uniformity were observed in the high discharge pressure region.

As has been described, the antenna length should be selected so as to satisfy the inequality:
0.5(1/α)<the length of straight portion La<10(1/α),
which makes the reflected wave small to have excellent plasma uniformity.

The attenuation coefficient, theoretically, varies with gases, diameter of antenna, dielectric constant and thickness of dielectric attached around the antenna, plasma density (excitation electric power) and the like as is apparent from above descriptions. However, it was also confirmed that the optimal antenna length is not drastically changed with these parameters and still situated in the above-mentioned regions so long as the parameters are within the range of the experiments.

Amorphous Si solar cells were manufactured using the method of this invention by arranging substrates on both sides of array antenna. Consequently, the solar cell thus manufactured has a characteristic equivalent to that manufactured using the parallel-plate type discharge apparatus. The solar cells manufactured on the substrates placed on respective sides of antenna have nearly the same characteristics.

Thus, the present invention makes it possible to provide the discharge apparatus and the plasma processing method with high productivity. Moreover, low price solar cells can be realized using plasma CVD apparatus of this invention.

1. A discharge apparatus, comprising an antenna element having a configuration in which a first and a second straight conductor with the same length are placed in parallel and are electrically connected each other at the one end to have a grounded end at other end of the first straight conductor and a power feeding end of alternating current power at the other end of the second straight conductor, a plurality of said antenna elements arranged to form an array antenna in such a way that the first and the second straight conductor are alternately placed in parallel at regular intervals on a first plane in a vacuum to generate a discharge plasma in the vacuum by feeding the alternating current power to said array antenna,
wherein the alternating current electric powers with the same excitation frequency and the phase shift of 180 degrees between adjacent power feeding ends are fed to said power feeding ends simultaneously, the excitation frequency of the alternating current power is 10 MHz-2 GHz, and the length of said conductors is set so that the measured ratio of reflected wave to incident wave is 0.1 or less at the power feeding end.

2. A discharge apparatus, comprising an antenna element having a configuration in which a first and a second straight conductor with the same length are placed in parallel and are electrically connected each other at the one end to have a grounded end at the other end of the first straight conductor and a power feeding end of alternating current power at the other end of the second straight conductor, a plurality of said antenna elements arranged to form an array antenna in such a way that the first and the second conductor are alternately placed in parallel at regular intervals on a first plane in a vacuum to generate a discharge plasma in the vacuum by feeding the alternating current power to said array antenna,
wherein the alternating current electric powers with the same excitation frequency and the phase shift of 180 degrees between adjacent power feeding ends are fed to said power feeding ends simultaneously, the excitation frequency of the alternating current power is 10 MHz-400 MHz, and the length La of said straight conductors is set to hold the inequality:
0.5(1/α)<La<10(1/α)
in which a attenuation coefficient α(1/m) is expressed by:
$$α = - Im [ 6.28 f \sqrt{\frac{1.26 \times {10}^{- 6} ln ( \frac{δ}{3 \times {10}^{- 3}} )}{9.57 \times {10}^{10} + \frac{1.13 \times {10}^{11}}{{κ}_{p}} ln ( \frac{δ}{7 \times {10}^{- 3}} )}} ]$$
using a dielectric constant κₚ of plasma as a function of an excitation frequency f and a discharge pressure p (Pa), expressed by:
$${κ}_{p} = 1 - \frac{\frac{1.61 \times {10}^{17}}{{f}^{2}}}{1 - j1 .54 ( \frac{p}{f} ) \times {10}^{7}}$$
and a skin depth δ(m) of the electromagnetic field penetrating into the plasma, expressed by:
δ=−2.10ƒ×10⁻⁸Im[\sqrt{κₚ}]

3. The discharge apparatus according to claim 1, wherein said straight conductor has a diameter of 10 mm or less.

4. The discharge apparatus according to claim 2, wherein said straight conductor has a diameter of 10 mm or less.

5. The discharge apparatus according to claim 3, wherein said straight conductor has a diameter of 1 mm or more.

6. The discharge apparatus according to claim 4, wherein said straight conductor has a diameter of 1 mm or more.

7. The discharge apparatus according to claim 1, wherein the diameter of said straight conductor is varied in the longitudinal direction.

8. The discharge apparatus according to claim 2, wherein the diameter of said straight conductor is varied in the longitudinal direction.

9. The discharge apparatus according to claim 7, wherein said straight conductor has a diameter of 10 mm or less partially or entirely.

10. The discharge apparatus according to claim 8, wherein said straight conductor has a diameter of 10 mm or less partially or entirely.

11. The discharge apparatus according to claim 1, wherein said straight conductor is covered partially or entirely with a dielectric.

12. The discharge apparatus according to claim 2, wherein said straight conductor is covered partially or entirely with a dielectric.

13. The discharge apparatus according to claim 11, wherein the thickness of said dielectric is varied in the longitudinal direction of said straight conductor.

14. The discharge apparatus according to claim 12, wherein the thickness of said dielectric is varied in the longitudinal direction of said straight conductor.

15. The discharge apparatus according to claim 13, wherein the edge of said dielectric is tapered in the cross section.

16. The discharge apparatus according to claim 14, wherein the edge of said dielectric is tapered in the cross section.

17. The discharge apparatus according to claim 11, wherein said dielectric is formed spirally about the longitudinal direction of said straight conductor.

18. The discharge apparatus according to claim 12, wherein said dielectric is formed spirally about the longitudinal direction of said straight conductor.

19. The discharge apparatus according to claim 1, wherein substrate bodies are placed on a second and a third plane which is located at respective sides of said first plane to simultaneously process both the substrate bodies placed on the second and the third plane.

20. The discharge apparatus according to claim 2, wherein substrate bodies are placed on a second and a third plane which is located at respective sides of said first plane to simultaneously process both the substrate bodies placed on the second and the third plane.

21. The discharge apparatus according to claim 19, wherein a plurality of said array antennas are arranged in one vacuum chamber.

22. The discharge apparatus according to claim 20, wherein a plurality of said array antennas are arranged in one vacuum chamber.

23. A plasma processing method, comprising;
arranging a plurality of antenna elements, each having a configuration in which a first and a second straight conductor with the same length are placed in parallel and are electrically connected each other at the one end to have a grounded end at the other end of the first straight conductor and a power feeding end of alternating current power at the other end of the second straight conductor to form an array antenna in such a way that the first and the second conductor are alternately placed in parallel at regular intervals on a first plane in a vacuum, and
feeding the alternating current power to said array antenna to generate a discharge plasma in the vacuum,
wherein the alternating current electric powers with the same excitation frequency and the phase shift of 180 degrees between adjacent power feeding ends are fed to said power feeding ends simultaneously, the excitation frequency of the alternating current power is 10 MHz-2 GHz, and the length of said conductors is set so that the measured ratio of reflected wave to incident wave is 0.1 or less at the power feeding end.

24. A plasma processing method, comprising;
arranging a plurality of antenna elements, each having a configuration in which a first and a second straight conductor with the same length are placed in parallel and are electrically connected each other at the one end to have a grounded end at the other end of the first straight conductor and a power feeding end of alternating current power at the other end of the second straight conductor to form an array antenna in such a way that the first and the second conductors are alternately placed in parallel at regular intervals on a first plane in a vacuum, and
feeding the alternating current power to said array antenna to generate a discharge plasma in the vacuum,
wherein the alternating current electric powers of the same excitation frequency and the phase shift of 180 degrees between adjacent power feeding ends are fed to said power feeding ends simultaneously, the excitation frequency of the alternating current power is 10 MHz-400 MHz, and the length La of said straight conductors is set to hold the inequality;
0.5(1/α)<La<10(1/α)
in which a attenuation coefficient α(1/m) is given by:
$$α = - Im [ 6.28 f \sqrt{\frac{1.26 \times {10}^{- 6} ln ( \frac{δ}{3 \times {10}^{- 3}} )}{9.57 \times {10}^{10} + \frac{1.13 \times {10}^{11}}{{κ}_{p}} ln ( \frac{δ}{7 \times {10}^{- 3}} )}} ]$$
using a dielectric constant κp of plasma as a function of an excitation frequency f and a discharge pressure p (Pa), expressed by]
$${κ}_{p} = 1 - \frac{\frac{1.61 \times {10}^{17}}{{f}^{2}}}{1 - j1 .54 ( \frac{p}{f} ) \times {10}^{7}}$$
and a skin depth δ(m) of the electromagnetic field penetrating into the plasma, expressed by:
δ=−2.10ƒ×10⁻⁸Im[\sqrt{κₚ}]

25. A solar cell, composed of a semiconductor thin film including Si element formed using plasma CVD method, said plasma CVD method comprising;
arranging a plurality of antenna elements, each having a configuration in which a first and a second straight conductor with the same length are placed in parallel and are electrically connected each other at the one end to have a grounded end at the other end of the first straight conductor and a power feeding end of alternating current power at the other end of the second straight conductor to form an array antenna in such a way that the first and the second conductor are alternately placed in parallel at regular intervals on a first plane in a vacuum, and
feeding the alternating current power to said array antenna to generate a discharge plasma in the vacuum,
wherein the alternating current electric powers with the same excitation frequency and the phase sift of 180 degrees between adjacent power feeding ends are fed to said power feeding ends simultaneously, the excitation frequency of the alternating current power is 10 MHz-2 GHz, and the length of said conductors is set so that the measured ratio of reflected wave to incident wave is 0.1 or less at the power feeding end.

26. A solar cell, composed of a semiconductor thin film including Si element formed using plasma CVD method, said plasma CVD method comprising;
arranging a plurality of antenna elements, each having a configuration in which a first and a second straight conductor with the same length are placed in parallel and are electrically connected each other at the one end to have a grounded end at the other end of the first straight conductor and a power feeding end of alternating current power at the other end of the second straight conductor to form an array antenna in such a way that the first and the second conductor are alternately placed in parallel at regular intervals on a first plane in a vacuum, and
feeding alternating current power to said array antenna to generate a discharge plasma in the vacuum,
wherein the alternating current electric powers of the same excitation frequency and the phase shift of 180 degrees between adjacent power feeding ends are fed to said power feeding ends simultaneously, the excitation frequency of the alternating current power is 10 MHz-400 MHz, and the length La of said straight conductor is set to hold the inequality:
0.5(1/α)<La<10(1/α)
in which a attenuation coefficient α(1/m) is given by:
$$α = - Im [ 6.28 f \sqrt{\frac{1.26 \times {10}^{- 6} ln ( \frac{δ}{3 \times {10}^{- 3}} )}{9.57 \times {10}^{10} + \frac{1.13 \times {10}^{11}}{{κ}_{p}} ln ( \frac{δ}{7 \times {10}^{- 3}} )}} ]$$
using a dielectric constant κp of plasma as a function of an excitation frequency f and a discharge pressure p (Pa), expressed by:
$${κ}_{p} = 1 - \frac{\frac{1.61 \times {10}^{17}}{{f}^{2}}}{1 - j1 .54 ( \frac{p}{f} ) \times {10}^{7}}$$
and a skin depth δ(m) of the electromagnetic field penetrating into the plasma, expressed by:
δ=−2.1ƒ×10⁻⁸Im[\sqrt{κₚ}]
